(19) United States
(12) Patent Application Publication
(10) Pub. No.: US 2005/0283581 A1
(43) Pub. Date: Dec. 22, 2005

(54) Data reading structure

(76) Inventor: Chen Min Chiang, Chuiung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/868,214

(22) Filed: Jun. 16, 2004

(51) Int. Cl. G06F 12/00

(52) U.S. Cl. 711/167

(57) ABSTRACT

A data reading structure for a 8-bit microprocessor to read several bytes of data at a time has a memory module and a selector module. The memory module has a first memory having a first and second data output ports and a second memory has a third and fourth data output ports. The selector module has a first data selector, a second data selector and a third data selector. The first, second and third data selectors respectively select one output from the first, second, third and fourth data output ports. Thereby, the microprocessor is allowed to read successively three bytes of data from an output terminal of the selector module during a memory read cycle to reduce the fetch time of an instruction.

### BACKGROUND OF THE INVENTION

1. Field of the Invention

The present invention relates to a data reading structure, and particularly, to a data reading structure that outputs plural bytes of data at a time for successive reading by a microprocessor.

2. Description of the Related Art With the increasing development of integrated circuit process technology, there is a rising trend of system-on-chip (SoC) in the field of IC design. Particularly, the 8051 series single-chip microprocessor developed by Intel Corp. is popularly used in the electronic industry.

However, the 8051 microprocessor is an 8-bit CPU specially designed for control applications, that is, a processor capable of processing an 8-bit data segment each time. Therefore, during execution, the 8051 microprocessor is allowed to read only one 8-bit executable code at a time. Instructions in the instruction set of the 8051 microprocessor are grouped based on their functions into five categories: arithmetic operation instructions, logic operation instructions, data transfer instructions, Boolean variable manipulation instructions and program branching instructions. As for the memory occupation for an instruction, each of the instructions in all categories except logic operation may occupy up to three bytes. An example of such instructions is ANL direct,#data.

For this reason, when executing an instruction occupying three bytes, the 8051 microprocessor must read the memory three times to obtain complete instructions that guarantee the correct execution of the instruction. Hence, execution performance is low because the 8051 microprocessor must wait for the complete reading of the 3-byte instructions, which consumes more time.

### SUMMARY OF THE INVENTION

The object of the present invention is to provide a data reading structure, which simultaneously outputs plural bytes of data so as to reduce the time required for a microprocessor to read data stored in a memory.

To achieve the above object, the present invention provides a data reading structure for a microprocessor to read data that comprises a memory module having a plurality of data output ports and a selector module coupled to the memory module for selecting a combination of outputs from the plurality of data output ports. Thereby, the microprocessor is allowed to successively read several bytes of data.

To achieve the above object, the present invention provides a data reading structure for a microprocessor to read data that comprises elements as follows. A first memory has a first data output port and a second data output port. A second memory has a third data output port and a fourth data output port. A first data selector is coupled to both the first memory and the second memory for selecting output from the first data output port, the second data output port, the third data output port or the fourth data output port. A second data selector is coupled to both the first memory and the second memory for selecting output from the first data output port, the second data output port, the third data output port or the fourth data output port. A third data selector is coupled to both the first memory and the second memory for selecting the output from the first data output port, the second data output port, the third data output port or the fourth data output port. Thereby, the microprocessor is allowed to read successively three bytes of data.

### BRIEF DESCRIPTION OF THE DRAWINGS

Features and advantages of the present invention will be fully understood from the detailed description to follow taken in conjunction with the embodiments as illustrated in the accompanying drawings, which are to be considered in all respects as illustrative and not restrictive, wherein:

FIG. 1 illustrates a hardware structure of a preferred embodiment according to the present invention;

FIG. 2A is a diagram showing the data stored in the memory module of the present invention; and

FIG. 2B is a table showing the 3-byte data output corresponding to each state of the address lines A1 and A0 according to the present invention.

### DETAILED DESCRIPTION OF PREFERRED EMBODIMENTS

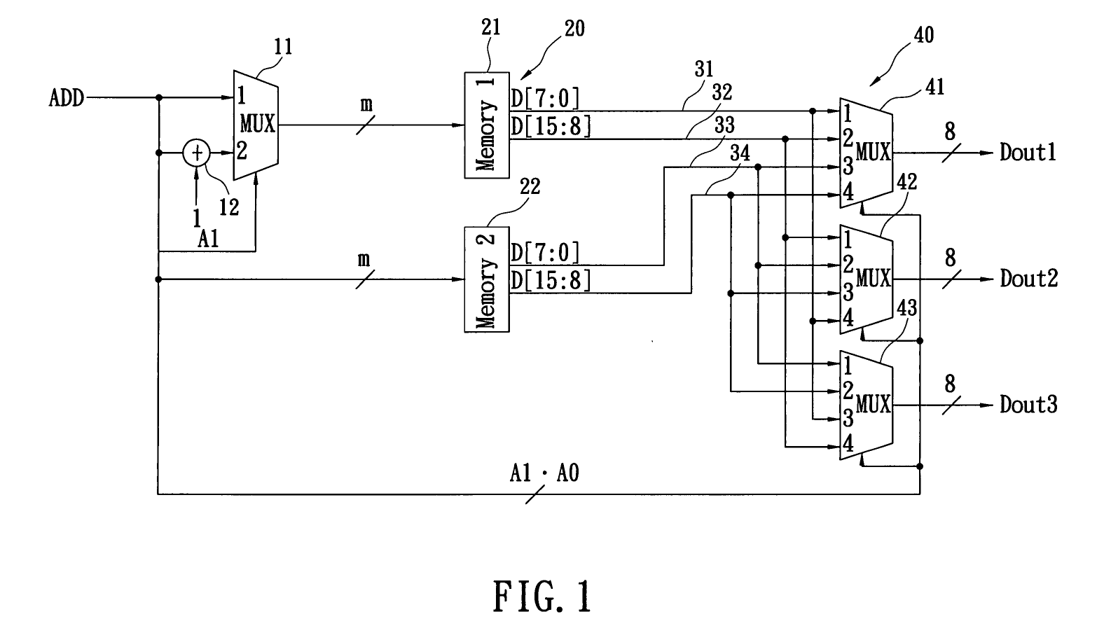

Referring to FIG. 1, a hardware structure of a preferred embodiment according to the present invention is illustrated. The invention provides a data reading structure that simultaneously outputs plural bytes of data during a memory read cycle for reading by a microprocessor (not shown). The invention comprises a memory module 20 and a selector module 40. The structure of the memory module 20 is provided with a plurality of data output ports, and, by taking a combination of the outputs from these data output ports through the selector module 40 coupled to output terminals of the memory module 20, it is possible for the microprocessor to read all the data bytes stored in the memory at one time when fetching a set of instructions. Therefore, the time required by the microprocessor to fetch a set of instructions is reduced.

Specifically, the memory module 20 in this embodiment is comprised of a plurality of memories to output data for reading by the microprocessor in response to address signals of the microprocessor. The memory module 20 includes a first memory 21 having a first data output port 31 and a second data output port 32 and a second memory 22 having a third data output port 33 and a fourth data output port 34. Each of the first, second, third and fourth data output ports 31, 32, 33 and 34 is implemented to have an 8-bit data width, so each memory provides two bytes of data output. Consequently, the memory module 20 in this embodiment is capable of outputting four bytes of data.

An address port of the first memory 21 is coupled to a former stage multiplexer 11 having an input terminal coupled with an adder 12 and an address port of the microprocessor. The former stage multiplexer 11 selects one address from the adder 12 or the address port of the microprocessor for output to the address port of the first memory 21. A selection line of the former stage multiplexer 11 is fed by a signal on the address line A1 from the microprocessor. The adder 12 operates to add one to the data from the address port of the microprocessor.

The selector module 40 in this embodiment includes a first data selector 41, a second data selector 42 and a third data selector 43 and simultaneously outputs three out of the four data bytes from the memory module. Which three data bytes are to be output depends on the respective decisions of the first data selector 41, the second data selector 42 and the third data selector 43.

The first data selector 41 is coupled to data output terminals of both the first memory 21 and the second memory 22. In this embodiment, the first data selector 41 is a 4×1 multiplexer. The first data output port 31 is coupled to a first input terminal of the first data selector 41. The second data output port 32 is coupled to a second input terminal of the first data selector 41. The third data output port 33 is coupled to a third input terminal of the first data selector 41. The fourth data output port 34 is coupled to a fourth input terminal of the first data selector 41. The first data selector 41 is controlled to select one of the data bytes from the first, second, third and fourth data output ports 31, 32, 33 and 34 as an output.

The second data selector 42 is coupled to data output terminals of both the first memory 21 and the second memory 22. In this embodiment, the second data selector 42 is a 4×1 multiplexer. The first data output port 31 is coupled to a fourth input terminal of the second data selector 42. The second data output port 32 is coupled to a first input terminal of the second data selector 42. The third data output port 33 is coupled to a second input terminal of the second data selector 42. The fourth data output port 34 is coupled to a third input terminal of the second data selector 42. The second data selector 42 is controlled to select one of the data bytes from the first, second, third and fourth data output ports 31, 32, 33 and 34 as an output.

The third data selector 43 is coupled to data output terminals of both the first memory 21 and the second memory 22. In this embodiment, the third data selector 43 is a 4×1 multiplexer. The first data output port 31 is coupled to a third input terminal of the third data selector 43. The second data output port 32 is coupled to a fourth input terminal of the third data selector 43. The third data output port 33 is coupled to a first input terminal of the third data selector 43. The fourth data output port 34 is coupled to a second input terminal of the third data selector 43. The third data selector 43 is controlled to select one of the data bytes from the first, second, third and fourth data output ports 31, 32, 33 and 34 as an output.

Selection lines of the first, second and third data selectors 41, 42 and 43 are coupled to the address port of the microprocessor and two address lines A1 and A0 are utilized as selection signals.

In this embodiment, the data output of the memory module 20 is expanded to have a 32-bit data width by using the first memory 21 and the second memory 22, each having a 16-bit data width. The first 16 bits of the data output are provided by the first memory 21 while the last 16 bits of the data output are provided by the second memory 22. Hence, in response to receiving address signals from the microprocessor, the memory module 20 simultaneous outputs 32 bits of data, which are grouped into four groups, each containing one byte of data.

In the above description, constituting components in this embodiment and the connection thereof having been fully explained. Next, operation of the embodiment to simultaneously output plural bytes of data for reading by the microprocessor will be described. In this embodiment, three bytes of data are output simultaneously so that the 8051 microprocessor is allowed to read an instruction having three bytes of executable codes at a time.

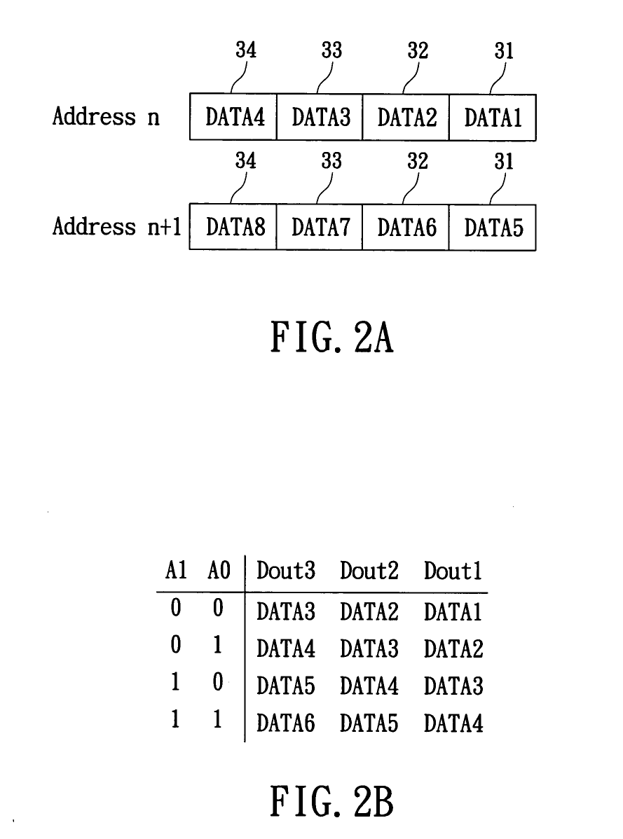

Referring to both FIGS. 2A and 2B, data read out by the memory module 20 at an address n are sequentially output as DATA1 at the first data output port 31, DATA2 at the second data output port 32, DATA3 at the third data output port 33 and DATA4 at the fourth data output port 34, while data read out by the memory module 20 at an address n+1 are sequentially output as DATA5 at the first data output port 31, DATA6 at the second data output port 32, DATA7 at the third data output port 33 and DATA8 at the fourth data output port 34.

Accordingly, in the structure of this embodiment, for the microprocessor to read DATA1, DATA2 and DATA3 successively, the address n is sent to the memory module 20 from the microprocessor and the address lines A0 and A1 are respectively set as 00. At this time, the data byte at the first data output port 31 coupled to the first input terminal of the first data selector 41, the data byte at the second data output port 32 coupled to the first input terminal of the second data selector 42 and the data byte at the third data output port 33 coupled to the first input terminal of the third data selector 43 are respectively selected for output. Consequently, DATA1, DATA2 and DATA3 are obtained at the output Dout1 of the first data selector 41, the output Dout2 of the second data selector 42 and the output Dout3 of the third data selector 43, respectively.

For the microprocessor to read DATA2, DATA3 and DATA4 successively, the address n is sent to the memory module 20 from the microprocessor and the address lines A0 and A1 are respectively set as 01. At this time, the data byte at the second data output port 32 coupled to the second input terminal of the first data selector 41, the data byte at the third data output port 33 coupled to the second input terminal of the second data selector 42 and the data byte at the fourth data output port 34 coupled to the second input terminal of the third data selector 43 are respectively selected for output. Consequently, DATA2, DATA3 and DATA4 are obtained at the output Dout1 of the first data selector 41, the output Dout2 of the second data selector 42 and the output Dout3 of the third data selector 43, respectively.

For the microprocessor to read DATA3, DATA4 and DATA5 successively, the address n is sent to the memory nodule 20 from the microprocessor and the address lines A0 and A1 are respectively set as 10. Meanwhile, the former stage multiplexer 11 is controlled by the signal “1” on the address line A1 to select and send the address n+1 to the first memory 21. At this time, the data byte at the third data output port 33 coupled to the third input terminal of the first data selector 41, data byte at the fourth data output port 34 coupled to the third input terminal of the second data selector 42 and data byte at the first data output port 31 coupled to the third input terminal of the third data selector 43 are respectively selected for output. Consequently, DATA3, DATA4 and DATA5 are obtained at the output Dout1 of the first data selector 41, the output Dout2 of the second data selector 42 and the output Dout3 of the third data selector 43, respectively.

For the microprocessor to read DATA4, DATA5 and DATA6 successively, the address n is sent to the memory module 20 from the microprocessor and the address lines A0 and A1 are respectively set as 11. Since the signal on the address line A1 is “1”, the former stage multiplexer 11 selects and sends the address n+1 to the first memory 21. At this time, the data byte at the fourth data output port 34 coupled to the fourth input terminal of the first data selector 41, the data byte at the first data output port 31 coupled to the fourth input terminal of the second data selector 42 and the data byte at the second data output port 32 coupled to the fourth input terminal of the third data selector 43 are respectively selected for output. Consequently, DATA4, DATA5 and DATA6 are obtained at the output Dout1 of the first data selector 41, the output Dout2 of the second data selector 42 and the output Dout3 of the third data selector 43, respectively.

For the microprocessor to read DATA5, DATA6 and DATA7 successively, the address n+1 is sent to the memory module 20 from the microprocessor and the address lines A0 and A1 are respectively set as 00. Operation of the selector module 40 is similar as described above and therefore the description is omitted for brevity. It is thus concluded that, in the structure of this embodiment, by sending the data address from the microprocessor and varying the states of the selection lines, the selector module 40 is controlled to simultaneously output three bytes of data at its output terminals during a memory read cycle so that the microprocessor is allowed to successively read three bytes of data stored in the memory module 20.

In the prior art, for an 8051 microprocessor designed to process data with an 8-bit data width, the memory must be read three times to fetch complete execution codes for a set of instructions since the execution codes of a set of instructions may occupy up to three bytes in the memory. By contrast, the structure in this embodiment takes only one reading operation to fetch complete execution codes for a set of instructions.

Therefore, the data reading structure according to the present invention has the following advantages:

(1) The invention is adapted to output plural bytes of data for successive reading by an 8-bit microprocessor.

(2) The invention effectively reduces the read time of the microprocessor and thus the execution performance is enhanced.

While the present invention has been described with reference to the detailed description and the drawings of the preferred embodiment thereof, it is to be understood that the invention should not be considered as limited thereby. Various modifications and changes could be conceived of by those skilled in the art without departuring from the scope of the present invention, which is indicated by the appended claims.

1. A data reading structure for a microprocessor to read data, comprising:
a memory module having a plurality of data output ports; and
a selector module coupled to said memory module for selecting a combination of outputs from said plurality of data output ports.

2. The data reading structure of claim 1, wherein said memory module is comprised of a plurality of memories.

3. The data reading structure of claim 1, wherein said data output port is an 8-bit output port.

4. The data reading structure of claim 1, wherein said selector module is comprised of a plurality of data selectors and said data selectors are respectively coupled to said data output ports.

5. The data reading structure of claim 4, wherein said data selectors are multiplexers and each of said multiplexers is used to select output from one of said data output ports.

6. The data reading structure of claim 4, wherein selection lines of said data selectors are coupled to an address port of said microprocessor.

7. A data reading structure for a microprocessor to read data, comprising:
a first memory having a first data output port and a second data output port;
a second memory having a third data output port and a fourth data output port;
a first data selector coupled to both said first memory and said second memory for selecting output from said first data output port, said second data output port, said third data output port or said fourth data output port;
a second data selector coupled to both said first memory and said second memory for selecting output from said first data output port, said second data output port, said third data output port or said fourth data output port; and
a third data selector coupled to both said first memory and said second memory for selecting output from said first data output port, said second data output port, said third data output port or said fourth data output port.

8. The data reading structure of claim 7, wherein said first data output port, said second data output port, said third data output port and said fourth data output port are 8-bit output ports.

9. The data reading structure of claim 7, wherein selection lines of said first data selector, said second data selector and said third data selector are coupled to an address port of said microprocessor.

10. The data reading structure of claim 7, wherein said first data selector is a 4×1 multiplexer having a first input terminal coupled to said first data output port, a second input terminal coupled to said second data output port, a third input terminal coupled to said third data output port and a fourth input terminal coupled to said fourth data output port.

11. The data reading structure of claim 7, wherein said second data selector is a 4×1 multiplexer having a first input terminal coupled to said second data output port, a second input terminal coupled to said third data output port, a third input terminal coupled to said fourth data output port and a fourth input terminal coupled to said first data output port.

12. The data reading structure of claim 7, wherein said third data selector is a 4×1 multiplexer having a first input terminal coupled to said third data output port, a second input terminal coupled to said fourth data output port, a third input terminal coupled to said first data output port and a fourth input terminal coupled to said second data output port.

13. The data reading structure of claim 7, further comprising a former stage multiplexer having an input terminal coupled to an adder and an address port of said microprocessor and an output terminal coupled to an address port of said first memory.

14. The data reading structure of claim 13, wherein said adder adds one to the output data at the address port of said microprocessor.

15. The data reading structure of claim 13, wherein a selection line of said former stage multiplexer is coupled to the address port of said microprocessor.
